(19) United States
(12) Patent Application Publication
(10) Pub. No.: US 2009/0100484 A1
(43) Pub. Date: Apr. 16, 2009

(54) SYSTEM AND METHOD FOR GENERATING OUTPUT MULTIMEDIA STREAM FROM A PLURALITY OF USER PARTIALLY- OR FULLY-ANIMATED MULTIMEDIA STREAMS

(75) Inventors: Yok Chaiwat, Sherman Oaks, CA (US); Raphael Ko, Sherman Oaks, CA (US); Linh Tang, Sherman Oaks, CA (US)

Correspondence Address: FOUNTAIN LAW GROUP, INC., 18201 VON KARMAN AVENUE, SUITE 960, IRVINE, CA, 92612, US

(73) Assignee: Mobinex, Inc., Sherman Oaks, CA (US)

(21) Appl. No.: 12/236,720

(22) Filed: Sep. 24, 2008

Related U.S. Application Data
(60) Provisional application No. 60/978,992, filed on Oct. 10, 2007.

(51) Int. Cl. H04N 7/173

(52) U.S. Cl. 725/109

(57) ABSTRACT

A system for generating an output multimedia stream user multimedia streams each comprising partially- or fully-animated images that track the movement, orientation, and facial expression of respective users, a non-user multimedia stream (e.g., television broadcast), graphic elements, and video and audio effects. The system includes a multiplexer that generates a multiplexed stream from a plurality of user multimedia streams, a selector for selecting one or more user multimedia stream from the multiplexed stream, a multimedia director device for generating the output multimedia stream from the selected streams, non-user multimedia stream, and added graphics and video effects. The output multimedia stream may be sent to the user devices for generating an interactive experience, such as an online gaming experience. These systems may be organized in a hierarchical manner, whereby regional systems provide multimedia streams to a central system that generates an output stream from the regional streams.

### CROSS REFERENCE TO A RELATED APPLICATION

This application claims priority to Provisional Patent Application, Ser. No. 60/978,992, filed on Oct. 10, 2007, and entitled “System and Method for Generating Output Multimedia Stream from a Plurality of User Partially- or Fully Animated Multimedia Sources,” which is incorporated herein by reference.

### FIELD OF THE INVENTION

This invention relates generally to image processing, and in particular, to a system and method for generating output multimedia stream from a plurality of partially- or fully-animated multimedia streams from users.

### BRIEF DESCRIPTION OF THE DRAWINGS

FIG. 1 illustrates a block diagram of an exemplary system for generating an output multimedia stream in accordance with an embodiment of the invention.

FIG. 2 illustrates a flow diagram of an exemplary method for generating an output multimedia stream in accordance with another embodiment of the invention.

FIG. 3 illustrates a frame or screen of an exemplary output multimedia stream in accordance with another embodiment of the invention.

FIG. 4 illustrates a flow diagram of an exemplary method of generating an output multimedia stream including user interactivity in accordance with another embodiment of the invention.

FIG. 5 illustrates a block diagram of an exemplary user multimedia source system in accordance with an embodiment of the invention.

FIG. 6 illustrates a block diagram of another exemplary user multimedia source system in accordance with another embodiment of the invention.

### DETAILED DESCRIPTION OF THE EXEMPLARY EMBODIMENTS

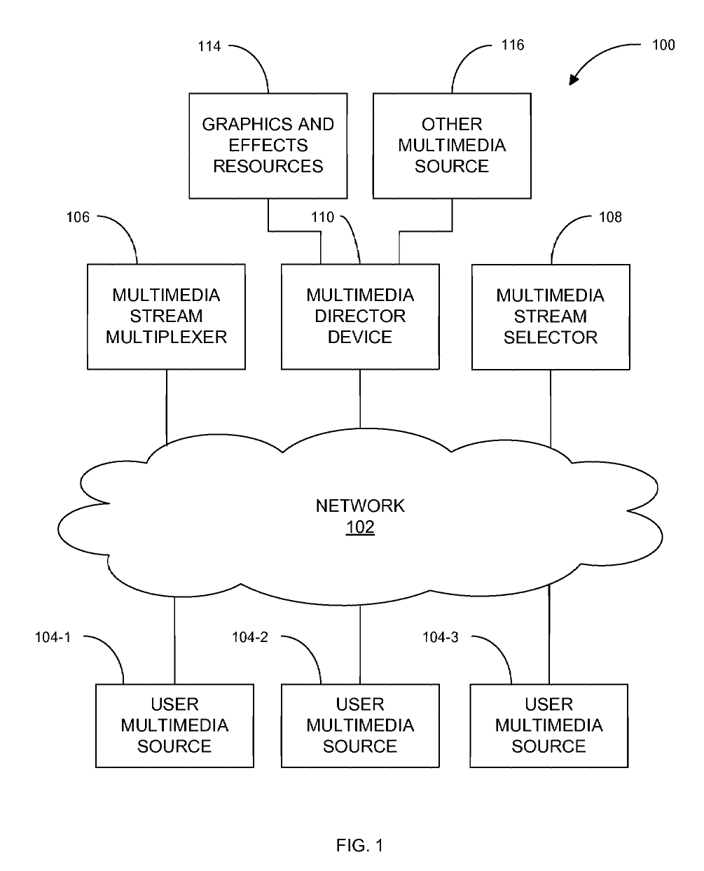

FIG. 1 illustrates a block diagram of an exemplary system 100 for generating an output multimedia stream in accordance with an embodiment of the invention. In summary, the system 100 receives a plurality of multimedia streams from users that include images which are partially- or fully-animated and track the movement, orientation, and expression of the respective users. The system 100 then generates an output multimedia stream that includes one or more of the user multimedia streams, one or more multimedia streams from other one or more sources, graphics and effects. The system 100 may then send the output multimedia stream to one or more users. The users may interact with the output multimedia stream, and consequently send one or more responsive or interacting user multimedia streams to the system 100. This process is repeated to provide an interactive experience for the users, such as an interactive game for the users.

Additionally, the system 100 may be a part of a hierarchical system having a higher-level multimedia director device which receives output multimedia streams from lower-level multimedia director device, such as device 110 of system 100. For example, the system 100 may be a regional broadcast system which sends its one or more output multimedia stream to a central broadcast system, which aggregates output multimedia streams from other regional systems to generate an output multimedia stream which incorporates some or all of the lower-level output multimedia streams.

In particular, the system 100 comprises a network 102, a plurality of user multimedia sources 104-1, 104-2, and 104-3, a multimedia stream multiplexer 106, a multimedia stream selector 108, a multimedia director device 110, graphics and effects resources 114, and one or more other multimedia sources 116.

The network 102 facilitates communications between the various elements coupled to the network 102 as shown. The network 102 may comprise a local area network (LAN), a wide area network (WAN), the Internet, a cellular wireless communications network, any combination thereof, or others. Additionally, the network 102 may comprise a broadcast network system, such as a cable or satellite broadcast system. As an example, the user multimedia source could be a set top box for television and the network could be a cable or broadcast network with the director able to receive multimedia streams from user' set top boxes.

Each user multimedia source (104-1, 104-2, or 104-3) generates a multimedia stream which includes a video stream that includes a partially- or fully-animated image that tracks the movement, orientation, and expression of the corresponding user. As discussed in more detail below, each user multimedia source includes a camera that generates a video image of the corresponding user. Each user multimedia source then generates a partially- or fully-animated video image that tracks the movement, orientation, and expression of the corresponding user. Each user multimedia source includes a microphone and related circuitry to generate an audio stream of the user speaking. Each user multimedia source may then generate an altered audio stream that is based on the user's voice audio stream. Accordingly, the multimedia stream may then comprise a synchronized combination of the partially- or fully-animated video stream and the altered or non-altered audio stream of the user's voice. The user multimedia stream may also include static image, sound, pre-recorded video or any multimedia content. The multimedia stream need not be “real time” or “live” multimedia streams. The user multimedia source (104-1, 104-2, or 104-3) could be a personal computer-based system, a set top box, or other systems that can deliver user multimedia streams.

The multimedia stream multiplexer 106 receives the multimedia streams from the user multimedia sources 104-1, 104-2, and 104-3 via the network 102. Thus, the user multimedia multiplexer 106 serves as the system's contact point to receive the multimedia streams from user's that want to participate in the multimedia experience provided by the system 100. The multimedia stream multiplexer 106 then multiplexes the user multimedia streams, and sends the multiplexed media stream to the multimedia stream selector 108 via the network 102.

The multimedia stream selector 108, in turn, selects one or more of the user multimedia streams to generate a selected-user multimedia stream. In essence, a screener may operate the multimedia stream selector 108 to screen out undesirable one or more user multimedia streams. The multimedia stream selector 108 then sends the selected-user multimedia stream to the multimedia director device 110 via the network 102.

The multimedia director device 110 then generates an output multimedia stream that includes one or more of the selected multimedia streams, other multimedia streams (e.g., broadcast television multimedia streams) from the other multimedia source 116, and graphics and multimedia effects from a graphics and effects resource library 114. Although, in this example, the other media source 116 and graphics and effects resource library 114 are coupled directly to the multimedia director device 110, it shall be understood that these elements 114 and 116 may be coupled to the multimedia director device 110 via the network 102. The multimedia director device 110 may be operated by a director responsible for the final output multimedia stream.

For example, the director may operate the multimedia director device 110 to position, size, and orient the one or more user multimedia video streams in desired locations on the output screen. The director may also operate the multimedia director device 110 to position, size, and orient the one or more other multimedia video streams (e.g., from a television source) in desired locations on the output screen. Additionally, the director may operate the multimedia director device 110 to add graphics, such as a background, borders for the respective user multimedia video streams, text to identify the respective user multimedia video streams. Also, the director may operate the multimedia director device 110 to add visual effects, such as transitions (e.g., scene transitions), fading, emphasizing effects, deemphasizing effects, and others. Further, the director may operate the multimedia director device 110 to add sound effects to the one or more multimedia streams, such as panning, echoing, reverb, compression, alteration, and others.

The multimedia director device 110 may then send the output multimedia stream to the users' devices 104-1, 104-2, and 104 or those selected therefrom, to provide an interactive experience for the users. This may be particularly useful for interactive gaming. In this regard, the users responsively interact with the output video stream, to generate responsive user multimedia streams. These responsive user multimedia streams or movements are then sent to the multimedia director device 110, which generates an output multimedia stream that incorporates the responsive user multimedia streams. The process is repeated to provide an interactive experience of the users. The output multimedia stream may also be publicly or semi-publicly distributed to provide an audience for the interactive experience.

Additionally, the multimedia director device 110 may generate a plurality of output multimedia streams. As an example, the multimedia director device 110 may generate an output multimedia stream for user A which includes video and audio of user B, and may generate an output multimedia stream for user B which includes video and audio of user A. This may be particularly useful for interactive gaming applications.

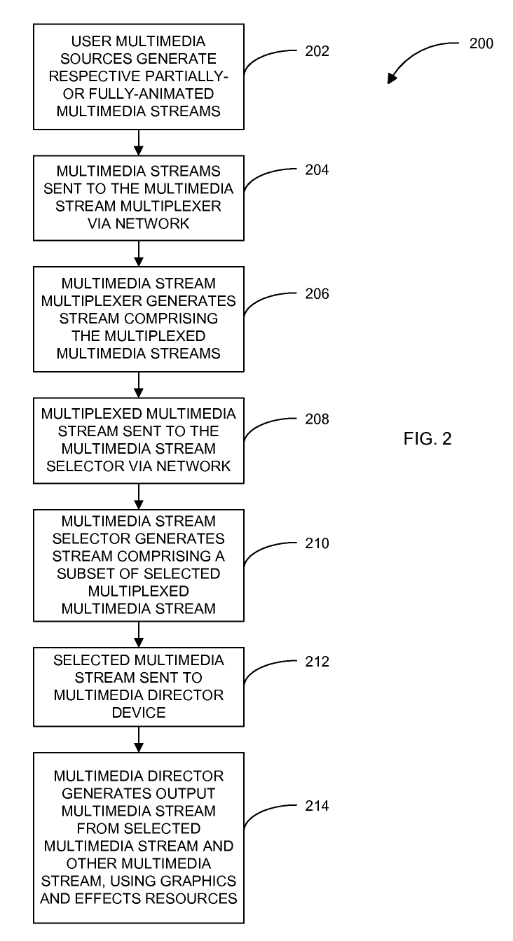

FIG. 2 illustrates a flow diagram of an exemplary method 200 for generating an output multimedia stream in accordance with another embodiment of the invention. According to the method 200, the user multimedia sources 104-1, 104-2, and 104-3 generate respective partially- or fully-animated multimedia streams (block 202). As discussed in more detail below, the user multimedia streams includes at least one partially- or fully-animated image that tracks the movement, orientation, and expression of the respective user. The multimedia streams from the user multimedia sources 104-1, 104-2, and 104-3 are sent to the multimedia stream multiplexer 106 via the network 102 (block 204).

The multimedia stream multiplexer 106 then multiplexes the user multimedia streams (block 206). The multimedia stream multiplexer 106 then sends the multiplex user multimedia streams to the multimedia stream selector 108 via the network 102 (block 208). Then, in response to a screener, the multimedia stream selector 108 selects one or more of the user multimedia streams (block 210). The multimedia stream selector 108 then sends the selected user multimedia streams to the multimedia director device 110 via the network 102 (block 212).

The multimedia director device 110 then generates an output multimedia stream based on the selected user multimedia streams, other multimedia streams (e.g., a television stream) from the other multimedia source 116, and applicable graphics and effects from the graphics and effects resource library 114 (block 214). The output multimedia stream may be broadcasted for viewing by an audience, may also be sent to the user devices 104-1, 104-2, and 104-3 to provide an interactive experience, such as an interactive game, may be recorded for further distribution and sales, and may be used for other applications.

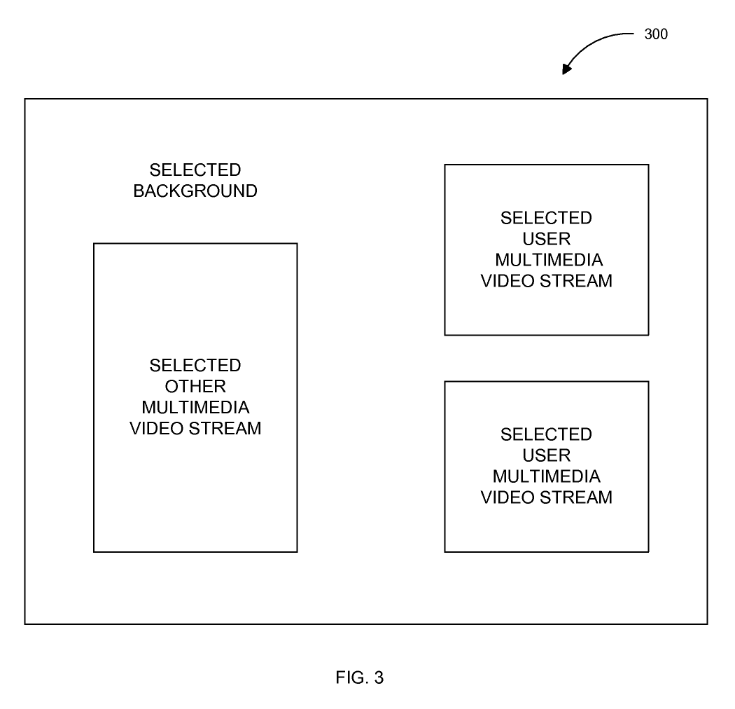

FIG. 3 illustrates a frame or screen of an exemplary output multimedia stream 300 in accordance with another embodiment of the invention. The screen 300 shows a first selected user multimedia video stream provided within a sub-frame or container that is positioned in the upper-right portion of the screen. The screen 300 also shows a second selected user multimedia video stream provided within another sub-frame or container that is positioned in the lower-right portion of the screen. The screen 300 also shows a selected other multimedia video stream (e.g., a television multimedia stream) provided within another sub-frame or container that is positioned in the lower-left portion of the screen. The screen 300 may also show a selected background on which the multimedia streams are placed in the foreground. All of these elements of the screen 300 and others may be configured or provided by the director operating the multimedia director device 110. The screen 300 may be configured in any manner as desired by the director.

As previously discussed, the output multimedia stream generated by system 100 may be sent to a higher-level director device as a part of a hierarchical system, which aggregates output multimedia streams from other lower-level systems to generate an output multimedia stream which incorporates some or all of the lower-level output multimedia streams.

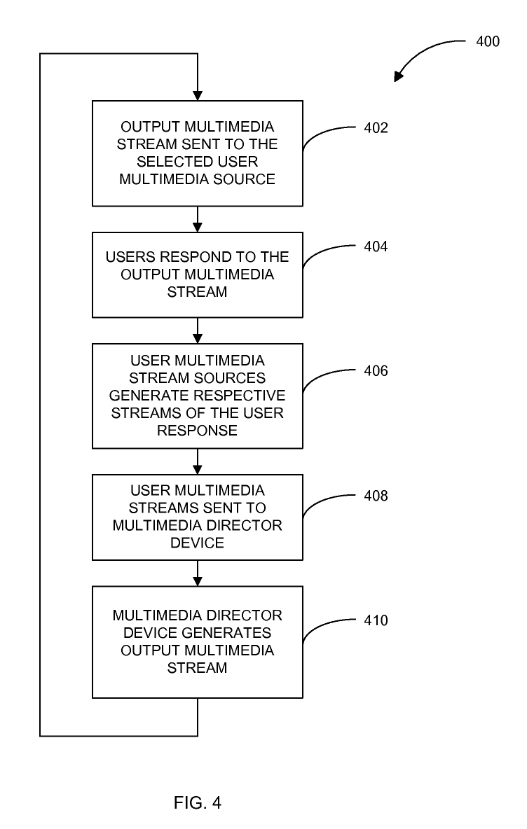

FIG. 4 illustrates a flow diagram of an exemplary method 400 of generating an output multimedia stream including user interactivity in accordance with another embodiment of the invention. According to the method 400, the output multimedia stream generated by the multimedia director device 110 is sent to the selected users 104-1, 104-2, and/or 104-3 via the network 102 (block 402). The users view and respond to the output multimedia stream (block 404). For example, the host of an interactive gaming show, which may be illustrated in the other multimedia stream portion of the output multimedia stream, may ask the users to perform certain acts, possibly in response to stream being viewed by the participants or players.

The user multimedia stream sources generate respective streams of the user response (block 406). Taking the above example, the host may have asked the user to respond to a particular question or to perform a particular act. The user multimedia source devices respectively captures the responses, and generate corresponding user multimedia streams. The user multimedia streams are then sent to the multimedia director device 110 via the network 102 and possibly other devices, such as the multiplexer 106 and selector 108 (block 408). The multimedia director device 110 then generates an output multimedia stream that incorporates the response user multimedia streams (block 410). The method 400 is then repeated to provide an interactive experience for the users. As previously discussed, the output multimedia stream may be broadcasted to a public or semi-public audience. Additionally, the output multimedia stream may be recorded for subsequent public or semi-public distributions.

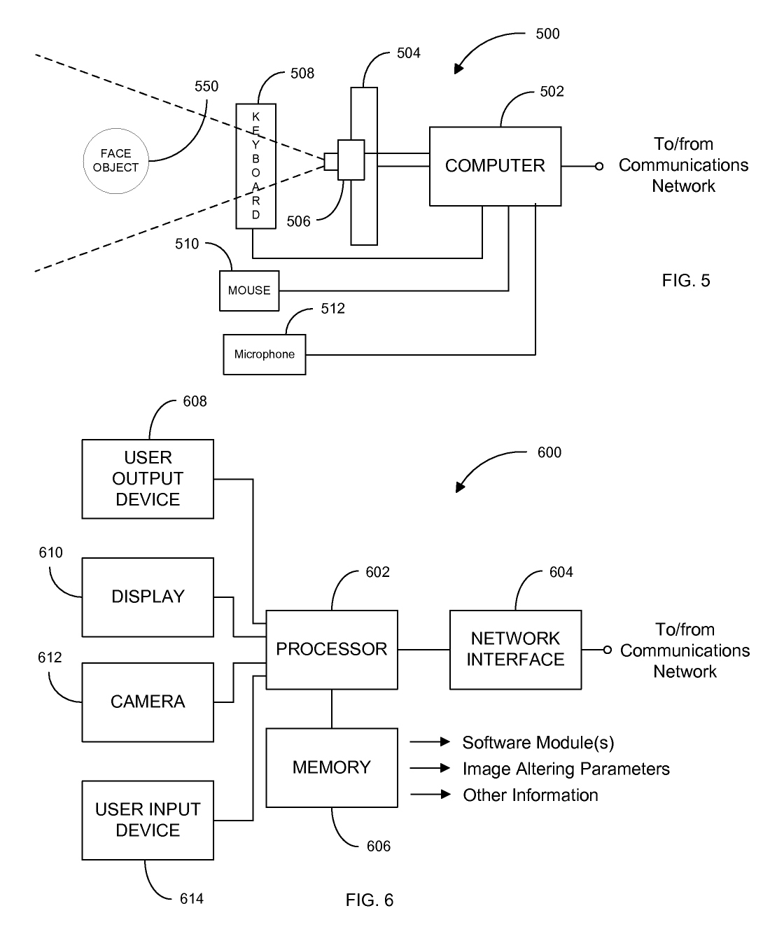

FIG. 5 illustrates a block diagram of an exemplary user multimedia source system 500 in accordance with an embodiment of the invention. The user multimedia source system 500 is particularly suited for tracking the movement, orientation, and expression of facial or other body parts of one or more users, and generating one or more corresponding partially- or fully-animated images that track the movement, orientation, and expression of the user(s). The user multimedia source system 500 is a computer-based system that operates under the control of one or more software modules to implement this functionality and others, as discussed in more detail below.

In particular, the system comprises a computer 502, a display 504 coupled to the computer 502, a still-picture and/or video camera 506 coupled to the computer 502, a keyboard 508 coupled to the computer 502, a mouse 510 coupled to the computer 502, and a microphone 512 coupled to the computer 502. The camera 506 generates a video image of one or more faces that appear in its view, such as that of person 550. The camera 506 provides the video image to the computer 502 for generating a corresponding partially-animated or fully-animated images on the display 504 that tracks the movement, orientation, and expression of the capture face images. The microphone 512 captures voice uttered by the user to generate an audio stream.

The keyboard 508 and mouse 510 allows a user to interact with software running of the computer 502 to control the video image capture of the person 550 and the generation of the corresponding altered images on the display 504. For instance, the keyboard 508 and mouse 510 allows a user to design the altered images corresponding to the person 550. For example, a user may design an altered image corresponding to the person 550 that includes at least partial of the captured face image and additional graphics to be overlaid with the at least partial captured face image. As an example, a user may design an altered image that adds a graphical hat or eyeglasses to the captured face image. The user may design a full graphical altered image, typically termed in the art as an “avatar”, corresponding to the face 550.

Once the user has created the corresponding altered images for the person 550, the user may interact with the software running on the computer 502 to track the movement, orientation, and expression of the faces and to generate the corresponding altered image on the display 504 that track the movement, orientation, and expression of the corresponding person. For example, when the person 550 moves laterally, the corresponding altered images on the display 504 also move laterally with the person 550 in substantially “real time.” Similarly, when the person 550 changes orientation by, for example, yawing or pitching, the corresponding altered image on the display 504 also change its orientation with the person 550 in substantially “real time.” Additionally, when the person 550 changes facial expression, such as closing of one or both eyes, opening of the mouth, or raising of one or both eyebrows, the corresponding altered image on the display 504 also change facial expression with the face 550 in substantially “real time.”

The user may interact with the software running on the computer 502 to create a video clip or file of the altered images that track the movement, orientation, and expression of the captured image of the person 550. In this manner, a user can create an animated or partially animated video clip or file. The user may interact with the software running on the computer 502 to upload the video clip or file to a website for posting, allowing the public to view the video clip or file. This makes creating an animated or partial-animated video clip or file relatively easy. The user may send the animated or partial-animated video and audio stream to the multimedia director device as previously discussed. As previously discussed, the user may send static image, sound, pre-recorded video or any multimedia content. In other words, the multimedia stream need not be “real time” or “live” multimedia streams.

Additionally, the user may interact with the software running on the computer 502 to perform video instant messaging or video conferencing with the altered image being communicated instead of the actual image of the person 550. The user may communicate with the director, screener during pre-screening for a show or with other users during an interactive game show. This enhances the video instant messaging and conferencing experience.

FIG. 6 illustrates a block diagram of another exemplary user multimedia source system 600 in accordance with another embodiment of the invention. This may be a more detailed embodiment of the user multimedia source system 500 previously described. Similar to the previous embodiment, the image processing system 600 is particularly suited for tracking the movement, orientation, and expression of a person, such as his/her face or other body parts, and generating a corresponding altered images that tracks the movement, orientation, and expression of the person. The user multimedia source system 600 also allows a user to design the altered images, to generate a video clip or file of the altered images, and to transmit the altered image to another device on a shared network, as previously discussed.

In particular, the user multimedia source system 600 comprises a processor 602, a network interface 604 coupled to the processor 602, a memory 606 coupled to the processor 602, a display 610 coupled to the processor 602, a camera 612 coupled to the processor 602, a user output device 608 coupled to the processor 602, and a user input device 614 coupled to the processor 602. The processor 602, under the control of one or more software modules, performs the various operations described herein. The network interface 604 allows the processor 602 to send communications to and/or receive communications from other network devices. The memory 606 stores one or more software modules that control the processor 602 to perform its various operations. The memory 606 may also store image altering parameters and other information.

The display 610 generates images, such as the altered images that track the movement, orientation, and expression of the multiple places. The display 610 may also display other information, such as image altering tools, controls for creating a video clip or file, controls for transmitting the altered images to a device via a network, and images received from other network devices pursuant to a video instant messaging or video conferencing experience. The camera 612 captures the images of one or more users for the purpose of creating and displaying one or more corresponding altered images. The user output device 608 may include other devices for the user to receive information from the processor, such as speakers, etc. The user input device 614 may include devices that allow a user to send information to the processor 602, such as a keyboard, mouse, track ball, microphone, TV remote control, etc.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of generating an output multimedia stream, comprising:
receiving one or more selected user multimedia streams;
receiving other multimedia streams;
receiving graphics; and
integrating the one or more selected user multimedia streams, other multimedia streams and graphics to generate an output multimedia stream.

2. The method of claim 1, further comprising
receiving a plurality of user multimedia streams; and
selecting said one or more selected user multimedia streams from the plurality of user multimedia streams.

3. The method of claim 2, further comprising multiplexing said plurality of user multimedia streams.

4. The method of claim 1, wherein each selected user multimedia stream includes a partially- or fully-animated image that tracks the movement, orientation, and expression of a corresponding user.

5. The method of claim 1, wherein each selected user multimedia stream includes a static image, sound, or pre-recorded video.

6. The method of claim 1, wherein the other multimedia streams comprises a television stream.

7. The method of claim 1, further comprising applying one or more video effects or one or more audio effects to generate the output multimedia stream.

8. The method of claim 1, further comprising sending the output multimedia stream to one or more users pertaining respectively to the one or more selected user multimedia streams.

9. The method of claim 8, further comprising receiving one or more selected user multimedia streams that includes a partially- or fully-animated image that tracks the movement, orientation or expression of the corresponding one or more users responding to the output multimedia stream.

10. The method of claim 9, further comprising generating additional output multimedia streams that include the one or more selected user media streams that includes the partially- or fully-animated images that tracks the movement, orientation or expression of the corresponding one or more users responding to the output multimedia stream.

11. A system for generating an output multimedia stream, comprising:
a plurality of user multimedia sources adapted to generate respective user multimedia streams comprising partial- or fully-animated images that track the movement, orientation, and facial expression of respective users; and
a multimedia director device adapted to generate an output multimedia stream comprising one or more of the user multimedia streams.

12. The system of claim 11, wherein the output multimedia stream further comprises a non-user multimedia stream for simultaneous displaying with the one or more user multimedia streams.

13. The system of claim 12, wherein the non-user multimedia stream comprises a broadcast television multimedia stream.

14. The system of claim 13, wherein the output multimedia stream further comprises graphics for simultaneous displaying with the broadcast television multimedia stream and the one or more user multimedia streams.

15. The system of claim 14, wherein the output multimedia stream further comprises one or more video effects that affect the simultaneous displaying of the broadcast television multimedia stream and the one or more user multimedia streams.

16. The system of claim 11, wherein the output multimedia stream further comprises graphics for simultaneous displaying with the one or more user multimedia streams.

17. The system of claim 16, wherein the output multimedia stream further comprises one or more video effects that affect the simultaneous displaying of the graphics and the one or more user multimedia streams.

18. The system of claim 11, further comprising a multimedia stream multiplexer adapted to generate a multiplexed multimedia stream from the user multimedia streams.

19. The system of claim 18, further comprising a multimedia stream selector adapted to generate a selected multiplexed multimedia stream from a subset of the user multimedia streams in the multiplexed multimedia stream.

20. The system of claim 19, wherein the multimedia director device is adapted to generate the output multimedia stream from the selected multiplexed multimedia stream.

21. The system of claim 11, wherein the multimedia director device is adapted to send the output multimedia stream to the plurality of user multimedia sources to provide the respective users an interactive experience.

22. A hierarchical system for generating an output multimedia stream, comprising:
a plurality of first-level systems each comprising:
a plurality of user multimedia sources adapted to generate respective user multimedia streams comprising partial- or fully-animated images that track the movement, orientation, and facial expression of respective users; and
a first-level multimedia director device adapted to generate a first-level output multimedia stream comprising one or more of the user multimedia streams; and
a second-level system comprising a second-level multimedia director adapted to generate a second-level output multimedia stream from one or more of the first-level output multimedia streams.

23. The hierarchical system of claim 22, wherein one or more of the first-level system comprises a non-user multimedia source adapted to generate a non-user multimedia stream, wherein the first-level output multimedia stream includes at least a portion of the non-user multimedia stream.

24. The hierarchical system of claim 23, wherein the non-user multimedia source comprises a broadcast television source.

25. The hierarchical system of claim 22, wherein one or more of the first-level system further comprises a source adapted to generate graphics, wherein the first-level output multimedia stream includes at least some of said graphics.

26. The hierarchical system of claim 22, wherein one or more of the first-level system further comprises a source of video effects, wherein the first-level output multimedia stream includes one or more of said video effects.

27. The hierarchical system of claim 22, wherein one or more of the first-level system further comprises a multimedia stream multiplexer adapted to generate a multiplexed multimedia stream from the user multimedia streams.

28. The hierarchical system of claim 27, wherein one or more of the first-level system further comprises a multimedia stream selector adapted to generate a selected multiplexed multimedia stream from a subset of the user multimedia streams in the multiplexed multimedia stream.

29. The hierarchical system of claim 28, wherein the corresponding multimedia director device is adapted to generate the output multimedia stream from the selected multiplexed multimedia stream.

30. The system of claim 22, wherein the second-level multimedia director device is adapted to send the output multimedia stream to the plurality of user multimedia sources to provide the respective users an interactive experience.
